(19) United States
(12) Patent Application Publication
(10) Pub. No.: US 2013/0062114 A1
(43) Pub. Date: Mar. 14, 2013

(54) ANTICORROSIVE, COATED ELECTRIC WIRE WITH TERMINAL, AND WIRING HARNESS

(71) Applicants: Masato Inoue, Yokkaichi-shi (JP); Hiroshi Sudou, Yokkaichi-shi (JP); Yukiyasu Sakamoto, Yokkaichi-shi (JP); Hiroshi Yamaguchi, Yokkaichi-shi (JP); Hisahiro Yasuda, Yokkaichi-shi (JP); Tetsuya Nakamura, Yokkaichi-shi (JP); Shigeyuki Tanaka, Yokkaichi-shi (JP); Kazuo Nakashima, Yokkaichi-shi (JP)

(72) Inventors: Masato Inoue, Yokkaichi-shi (JP); Hiroshi Sudou, Yokkaichi-shi (JP); Yukiyasu Sakamoto, Yokkaichi-shi (JP); Hiroshi Yamaguchi, Yokkaichi-shi (JP); Hisahiro Yasuda, Yokkaichi-shi (JP); Tetsuya Nakamura, Yokkaichi-shi (JP); Shigeyuki Tanaka, Yokkaichi-shi (JP); Kazuo Nakashima, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/698,439

(22) PCT Filed: Jun. 9, 2011
(86) PCT No.: PCT/JP2011/063241

§ 371 Date: Nov. 16, 2012

(30) Foreign Application Priority Data
Jun. 9, 2010 (JP) 2010-131813

(51) Int. Cl. C09K 15/06; H02G 15/02

(52) U.S. Cl. 174/72 A; 174/74 R; 252/396

(57) ABSTRACT

An anticorrosive that is capable of demonstrating high anticorrosive capability. The anticorrosive mainly contains at least one of a photopolymerizable (meth)acrylate monomer and a photopolymerizable (meth)acrylate oligomer, and has a viscosity of 1000 mPa·s or more to less than 20000 mPa·s at 25 degrees C., which is measured in accordance with the JIS Z8803. The anticorrosive can be favorably applied to an electrically connected portion between a wire conductor of a coated electric wire with a terminal and a terminal member. The coated electric wire with the terminal includes the wire conductor and the terminal member, wherein the electrically connected portion between the wire conductor and the terminal member is coated with the anticorrosive that is cured.

### TECHNICAL FIELD

The present invention relates to an anticorrosive, a coated electric wire with a terminal, and a wiring harness, and more specifically relates to an anticorrosive that is favorably used to prevent corrosion from building up at an electrically connected portion between a wire conductor and a terminal member, a coated electric wire with a terminal using the anticorrosive, and a wiring harness using the anticorrosive.

### BACKGROUND ART

Conventionally, a coated electric wire, which is prepared by coating a wire conductor made of an annealed wire such as tough pitch copper with an insulation, is in widespread use as an electric wire used for wiring in a car such as an automobile. A terminal member is connected to the wire conductor at an end of the coated electric wire, where the wire conductor is exposed by stripping off the insulation. The terminal member that is electrically connected to the end of the coated electric wire is inserted and locked into a connector.

A plurality of the coated electric wires with the terminals are bunched into a wiring harness. The coated electric wires in the form of wiring harness are used for wiring in a car such as an automobile.

Used for wiring in an engine room or a certain indoor environment that is subject to water, the wiring harness is susceptible to heat and water, which results in formation of rust at electrically connected portions between the wire conductors and the terminal members. For this reason, it is necessary to prevent corrosion from building up at the electrically connected portions when the wiring harness is used in this environment.

In order to prevent corrosion from building up at the electrically connected portions, PTL 1 discloses a technique to fill with grease the connectors into which the terminal members connected to the wire conductors are inserted and locked.

### CITATION LIST

### Patent Literature

PTL1: JP05-159846A

### SUMMARY OF INVENTION

### Technical Problem

These days, there are increasing tendencies to improve fuel efficiency by weight reduction of a car such as an automobile, and accordingly weight reduction of material for the electric wires that make up the wiring harness is demanded. For this reason, using aluminum for the wire conductors is considered.

Copper or a copper alloy that has excellent electric properties is generally used for the terminal members, and accordingly the aluminum electric wires and the copper terminal members are often used in combination. However, when the wire conductors are different in material from the terminal members, bimetallic corrosion builds up at the electrically connected portions. This kind of corrosion builds up more easily compared with the case of using a same material for the wire conductors and the terminal members. For this reason, an anticorrosive is required, which can prevent corrosion from building up at the electrically connected portions in a convincing way.

However, the conventional grease is not capable of sufficiently preventing water immersion if it is not filled densely in the connectors. If the amount of grease filling is increased in order to enhance the anticorrosion effect, the grease it unintentionally coated on a portion where corrosion prevention is not needed. In addition, excessive filling makes the connectors and the electric wires sticky, which decreases handleability. For this reason, an anticorrosive that is capable of demonstrating high anticorrosive capability is required as a replacement for the problematic grease.

The present invention has been made in view of the above circumstances and has an object to overcome the above problems, and to provide an anticorrosive that is capable of demonstrating high anticorrosive capability. Other objects of the present invention are to provide a coated electric wire with a terminal using the anticorrosive, and to provide a wiring harness using the anticorrosive.

### Solution to Problem

In order to solve the problems described above, the anticorrosive of the present invention mainly contains at least one of a photopolymerizable (meth)acrylate monomer and a photopolymerizable (meth)acrylate oligomer, and has a viscosity of 1000 mPa·s or more to less than 20000 mPa·s at 25 degrees C., which is measured in accordance with the JIS Z8803.

It is preferable that the photopolymerizable (meth)acrylate monomer defines an ultraviolet curable (meth)acrylate monomer, and the photopolymerizable (meth)acrylate oligomer defines an ultraviolet curable (meth)acrylate oligomer.

It is preferable that the anticorrosive defines an anticorrosive that is applied to an electrically connected portion between a wire conductor and a terminal member.

In another aspect of the present invention, a coated electric wire with a terminal includes a wire conductor and a terminal member, wherein an electrically connected portion between the wire conductor and the terminal member is coated with the anticorrosive that is cured.

It is preferable that in the coated electric wire with the terminal, the wire conductor includes elemental wires made of aluminum or an aluminum alloy, and the terminal member is made of copper or a copper alloy.

Yet, in another aspect of the present invention, a wiring harness includes the coated electric wire with the terminal.

### Advantageous Effect of Invention

Mainly containing at least one of the photopolymerizable (meth)acrylate monomer and the photopolymerizable (meth)acrylate oligomer, and having the viscosity of 1000 mPa·s or more to less than 20000 mPa·s at 25 degrees C., which is measured in accordance with the JIS Z8803, the anticorrosive of the present invention has an excellent coating property compared with grease, and is capable of demonstrating high anticorrosive capability after being cured.

If the photopolymerizable (moth)acrylate monomer defines the ultraviolet curable (meth)acrylate monomer and the photopolymerizable (meth)acrylate)acrylate oligomer defines the ultraviolet curable (meth)acrylate oligomer, the anticorrosive of the present invention needs a short curing time and is excellent in handleability, which can contribute to improvement in productivity when the anticorrosive is used at the electrically connected portion between the wire conductor and the terminal member.

In addition, applied to the electrically connected portion between the wire conductor and the terminal member, the anticorrosive of the present invention can improve corrosion resistance capability of the electrically connected portion, which allows the electrically connected portion to have increased connecting reliability.

Having the configuration that the electrically connected portion between the wire conductor and the terminal member is coated with the anticorrosive that is cured, the coated electric wire of the present invention has the electrically connected portion that has improved corrosion resistance capability, which allows the coated electric wire to have increased connecting reliability.

If the wire conductor includes the elemental wires made of aluminum or an aluminum alloy and the terminal member is made of copper or a copper alloy, which establishes bimetallic connection, full use of the effect of the anticorrosive of the present invention can be made.

The wiring harness of the present invention includes the coated electric wire that has improved anticorrosive capability. Thus, the wiring harness can be used favorably for wiring in an engine room or a certain indoor environment that is subject to water.

### BRIEF DESCRIPTION OF DRAWINGS

FIG. 1 is a view showing a coated electric wire with a terminal of a first preferred embodiment of the present invention.

FIG. 2 is a cross-sectional view showing the same along the line A-A of FIG. 1.

FIG. 3 is a view or illustrating a corrosion test.

### DESCRIPTION OF EMBODIMENTS

Detailed descriptions of an anticorrosive of preferred embodiments of the present invention (hereinafter, referred to also as the “present anticorrosive”), a coated electric wire with a terminal of preferred embodiments of the present invention (hereinafter, referred to also as the “present coated electric wire”), and a wiring harness of preferred embodiments of the present invention (hereinafter, referred to also as the “present wiring harness”) will now be provided.

1. Present Anticorrosive

The present anticorrosive mainly contains a photopolymerizable (meth)acrylate monomer and/or a photopolymerizable (meth)acrylate oligomer. It is preferable that the photopolymerizable (meth)acrylate monomer defines a monofunctional monomer that has one functional group or a multifunctional monomer that has more than one functional group, and that the photopolymerizable (meth)acrylate oligomer defines a monofunctional oligomer that has one functional group or a multifunctional oligomer that has more than one functional group. The multifunctional monomer that has two functional groups is sometimes referred to as a bifunctional monomer, and the multifunctional oligomer that has two functional groups is sometimes referred to as a bifunctional oligomer. The multifunctional monomer that has three functional groups is sometimes referred to as a trifunctional monomer, and the multifunctional oligomer that has three functional groups is sometimes referred to as a trifunctional oligomer.

The present anticorrosive may contain one or more than one kind of photopolymerizable (meth)acrylate monomer. Alternatively, the present anticorrosive may contain one or more than one kind of photopolymerizable (meth)acrylate oligomer. Alternatively, the present anticorrosive may contain one or more than one kind of photopolymerizable (meth)acrylate monomer, and one or more than one kind of photopolymerizable (meth)acrylate oligomer.

Examples of the photopolymerizable (math) acrylate monomer and the photopolymerizable (meth)acrylate oligomer include EO (ethylene oxide)-modified isocyanurate diacrylate, modified e-caprolactone tris(acroxyethyl)isocyanurate, dipentaerythritol pentaacrylate, dipentaerythritol hexaacrylate, dipentaerythritol pentaacrylate and hexaacrylate, urethane acrylate, and polyester acrylate.

The present anticorrosive may consist of the photopolymerizable (meth)acrylate monomer alone, or the photopolymerizable (meth)acrylate oligomer alone. Alternatively, the present anticorrosive may consist of a mixture of the photopolymerizable (meth)acrylate monomer and the photopolymerizable (meth)acrylate oligomer. It is preferable that the present anticorrosive further contains an additive, another monomer, another oligomer, a thermoplastic polymer and/or a thermal curable polymer within a range of not impairing its physical properties.

The additive described above is not limited specifically, if an additive that can be generally used for a material for resin molding used. To be specific, examples of the additive include a curing agent, an inorganic filler, an antioxidant, a metal deactivator (a copper inhibitor), ultraviolet absorber, an ultraviolet-concealing agent, a flame-retardant auxiliary agent, a processing aid (e.g., a lubricant, wax), carbon and other coloring pigments, a flexibilizer, an agent providing shock resistance, an organic filler, a dilution agent (e.g., a solvent), a thixotropic agent, coupling agents of various kinds, a defoamer, and a levelling agent.

The present anticorrosive is an uncured material. The present anticorrosive is cured after being applied to a site such as a connected portion of a wire in order to increase mechanical strength of the site. A curing method is not limited specifically. Examples of the curing method include curing with ultraviolet irradiation, and curing with electron irradiation. It is preferable to use and cure an ultraviolet curable monomer and/or an ultraviolet, curable oligomer with ultraviolet irradiation. This is because thus-prepared anticorrosive needs a short curing time and is excellent in handleability, which can contribute to improvement in productivity when the anticorrosive is used at an electrically connected portion between a wire conductor and a terminal member. In addition, this is because the ultraviolet curable monomer and/or the ultraviolet durable oligomer can be cared at facilities for ultraviolet irradiation curing, which have a simpler structure than facilities for electron irradiation curing.

Means for light irradiation in the above-described irradiation is not limited specifically, and can be chosen appropriately depending on the intended use. Examples of the means include a known light irradiation device such as mercury lamp and a metal halide lamp. It is also possible to collect light emitted from a light irradiation device by using a reflection mirror, and irradiate the anticorrosive with the collected light. In addition, a spot-type light irradiation device may be used to irradiate the anticorrosive with substantially uniform irradiation light. The irradiation may be performed in the air or under an inert gas atmosphere of nitrogen or argon. In applying the present anticorrosive to the connected portion of the wire, if there exists a site where light such as ultraviolet light cannot easily reach or cannot reach such as space between elemental wires of a wire conductor and such as an area where a shadow of a terminal member lies, another curing method such a thermal curing and moisture curing can be used in addition to the light irradiation curing.

The present anticorrosive has a viscosity of 1000 mPa·s or more to less than 20000 mPa·s at 25 degrees C., which is measured in accordance with the JIS Z8803. That is, when the present anticorrosive consists of a single kind of acrylate alone that is selected from the acrylates described above, the viscosity of the acrylate is accordingly within this range. When the present anticorrosive consists of two or more than two kinds of acrylates selected from the acrylates described above, the viscosity of a mixture of the acrylates is accordingly within this range. When the present anticorrosive contains the other monomer, the other polymer and/or the other elements described above in addition to the acrylate, the viscosity of a mixture of the acrylate, the other monomer, the other polymer and/or the other elements, is accordingly within this range. In this measurement, a rotating viscometer is used.

If the viscosity is less than 1000 mPa·s, the anticorrosive material flows off when applied for coating, which makes it difficult to apply an enough amount of the anticorrosive to a site that requires anticorrosive capability. Thus, it is difficult for the site to obtain a high anticorrosion effect. The viscosity is preferably 1500 mPa·s or more, more preferably 1600 mPa·s or more, still more preferably 1800 mPa·s or more, and yet still more preferably 2000 mPa·s or more. On the other hand, if the viscosity is 20000 mPa·s or more, the anticorrosive material does not flow sufficiently when applied for coating, which makes it difficult to apply an enough amount of the anticorrosive to a site that requires anticorrosive capability. Thus, it is difficult for the site to obtain a high anticorrosion effect. The viscosity is preferably 18000 mPa·s or less, more preferably 17000 mPa·s or less, still more preferably 16000 mPa·s or less, and yet still more preferably 15000 mPa·s or less in view of productivity and anticorrosive capability.

For example, the present anticorrosive can be favorably used to prevent corrosion from building up at an electrically connected portion between a wire conductor and a terminal member of a coated electric wire that is used for wiring in a car such as an automobile.

2. Present Coated Electric Wire

Next, a description of the present coated electric wire is provided.

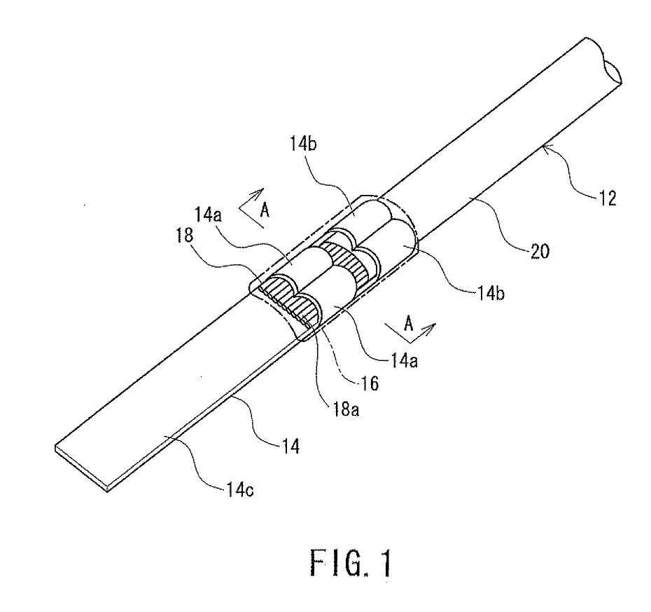

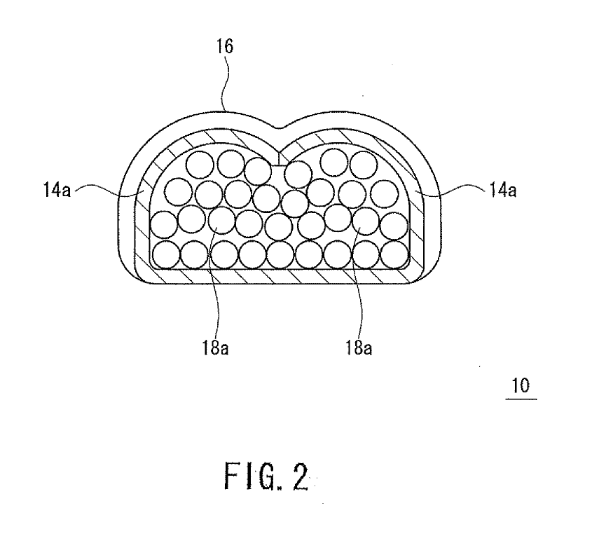

A present coated electric wire 10 includes a coated electric wire 12 including a wire conductor 18 and an insulation 20 with which the wire conductor 18 is coated, and a terminal member 14 connected to an end of the wire conductor 18 of the coated electric wire 12, as shown in FIGS. 1 and 2.

The insulation 20 is peeled off at the end of the wire conductor 18 of the coated electric wire 12, so that the wire conductor 18 is exposed at the end. The terminal member 14 is connected to the exposed end of the wire conductor 18. The wire conductor 18 defines a strand made up of a plurality of elemental wires 18a. In this case, the strand may be made up of metallic elemental wires of one kind, or may be made up of metallic elemental wires of more than one kind. The strand may include an elemental wire made of an organic fiber in addition to the metallic elemental wires. It is to be noted that the strand made up of the metallic elemental wires of one kind defines a strand made up of metallic elemental wires that are all made of a same metallic material, and the strand made up of the metallic elemental wires of more than one kind defines a strand made up of metallic elemental wires that are made of metallic materials different from each other. The strand may include also a reinforcement wire (tension member) for reinforcing the coated electric wire.

The metallic elemental wires are made preferably of copper, a copper alloy, aluminum, an aluminum alloy, or materials that are produced by furnishing these materials with plating of various kinds. An elemental wire that is defined as the reinforcement wire is made preferably of a copper alloy, titanium, tungsten or stainless steel. An elemental wire made of the organic, fiber that is defined as the reinforcement wire is made preferably of KEVLAR.

The insulation 20 is made preferably from rubber, polyolefin, PVC or a thermoplastic elastomer, which may be used singly or in combination. The insulation 20 may contain a variety of additives such as a flame retardant, a filler and a coloring agent as appropriate.

The terminal member 14 includes a connecting portion 14c having the shape of a tab and arranged to be connected to a counterpart terminal, wire barrels 14a extending from a base end of the connecting portion 14c and crimped onto the end of the wire conductor 18 of the electric wire 12, and insulation barrels 14b extending from the wire barrels 14a and crimped onto the insulation 20 at the end of the coated electric wire 12.

The terminal member 14 (a base member thereof) is made preferably of general brass, a variety of copper alloys or copper. It is preferable to plate a partial surface (e.g., a connecting point) or an entire surface of the terminal member 14 with a metal such as tin, nickel and gold.

A portion of the wire conductor 18 is exposed at an electrically connected portion between the wire conductor 18 and the terminal member 14 at the wire end. In the present coated electric wire 10, the exposed portion is coated with the anticorrosive described above. To be specific, a coating film 16 of the anticorrosive lies over from the base end of the connecting portion 14c while striding over the border between the base end of the connecting portion 14c of the terminal member 14 and the end of the wire conductor 18 until the insulation 20 while striding over the border between the insulation barrels 14b of the terminal member 14 and the insulation 20.

The anticorrosive to be used has the physical properties within the range described above, considering the combination of the material of the wire conductor 18 and the material of the terminal member 14. The thickness of the coating film 16 of the anticorrosive is adjusted as appropriate; however, the thickness is preferably from 0.01 mm to 0.1 mm. If the thickness of the coating film 16 is too large, it is difficult for the terminal member 14 to be inserted into a connector. On the other hand, if the thickness of the coating film 16 is too small, the anticorrosion effect is liable to be lessened.

after crimping the terminal member 14 onto the wire end to connect the wire conductor 18 and the terminal member 14, the anticorrosive is applied to a surface of the connected portion between the wire conductor 18 and the terminal member 14, that is, a surface at the end of the insulation 20, surfaces of the insulation barrels 14b, surfaces of the wire barrels 14a, a surface of the exposed wire conductor 18, and a surface of the base end of the connecting portion 14c. Thus, the coating film 16 is formed on the surface of the connected portion between the wire conductor 18 and the terminal member 14.

It is also preferable to form a coating film 16 of the anticorrosive on a back surface of the tab-shaped connecting portion 14c extending from the wire barrels 14a of the terminal member 14, back surfaces of the wire barrels 14a, and back surfaces of the insulation barrels 14b if the formed coating film 16 does not impair the electrical connection.

In applying the anticorrosive, a falling-drop method or a coating method is preferably used. The anticorrosive may be heated or cooled as necessary.

After the anticorrosive is applied to the connected portion of the wire, the coating film 16 of the anticorrosive can be cured with light irradiation such as ultraviolet irradiation in order to increase mechanical strength.

Being solidified after the curing, the anticorrosive is not sticky at the time of handling, and can be fixed to the applied site over a long period of time. Thus, the anticorrosion effect can be sustained over a long period of time.

3. Present Wiring Harness

A plurality of coated electric wires with terminals including the present coated electric wires 10 are bunched into the present wiring harness. In the present wiring harness, some of the included coated electric wires may be the present coated electric wires 10, or all of the included coated electric wires may be the present coated electric wires 10.

In the present wiring harness, the coated electric wires may be bound with tape, or may be armored with an armoring member such as a circular tube, a corrugated tube and a protector.

The present wiring harness is favorably used for wiring in a car such as an automobile, especially for wiring in an engine room or the interior of a car that is subject to water. These sites are susceptible to heat and water, so that when a wiring harness is used for wiring in these sites, rust is liable to form at an electrically connected portion between a wire conductor 18 and a terminal member 14. However, using the present wiring harness can effectively prevent rust from forming at the electrically connected portion between the wire conductor 18 and the terminal member 14.

### Example

A description of the present invention will now be specifically provided with reference to Examples. It is to be noted that the present invention is not limited to Examples.

1. Preparation of Coated Electric Wire

A polyvinyl chloride composition was prepared as follows: 100 parts by mass of polyvinyl chloride (polymerization degree of 1300) was mixed with 40 parts by mass of diisononyl phthalate that defines a plasticizer, 20 parts by mass of calcium carbonate heavy that defines a fillet, and 5 parts by mass of a calcium-zinc stabilizer that defines a stabilizer at 180 degrees C. in an open roll, and the mixture was formed into pellets with the use of pelletizer.

Then, a conductor (having a cross-sectional area of 0.75 mm) that defines an aluminum alloy strand that is made up of seven aluminum alloy wires was extrusion-coated with the polyvinyl chloride composition prepared as above such that the coat has a thickness of 0.28 mm. In this manner, coated electric wires (PVC electric wires) were prepared.

2. Preparation of Coated Electric Wire with Terminal

Coated electric wires with terminals were prepared as follows. The coat was peeled off at an end of each coated electric wire prepared as above to expose the wire conductor, and then a male crimping terminal member (0.64 mm in width at a tab) that is made of brass and generally used for automobile was crimped onto the end of each coated electric wire.

Then, anticorrosives of different kinds to be described later were applied to electrically connected portions between the wire conductors and the terminal members, and thus the exposed mire conductors and barrels of the terminal members were coated with the anticorrosives. Then, the portions coated with the anticorrosives were individually placed on a light-collecting area (focal area) of a UV light irradiation device of 800 watts including a metal halide lamp and a collection cold mirror (manuf.: ORC MANUFACTURING CO., LTD.) to be cured with ultraviolet irradiation by being irradiated with ultraviolet light of 5000 mJ/cm² or more. In this manner, the coated electric wires with the terminals were prepared. It is to be noted that the anticorrosives were applied such that the coats have a thickness of 0.05 mm.

### Example 1

Modified e-caprolactone tris(acroxyethyl)isocyanurate [manuf.: TOAGOSEI CO., LTD., “ARONIX M-327”, viscosity at 25 degrees C.: 1800 to 3000 mPa·s]

### Example 2

Dipentaerythritol pentaacrylate, and dipentaerythritol hexaacrylate [manuf.: TOAGOSEI CO., LTD., “ARONIX M-405”, viscosity at 25 degrees C.: 3700 to 5700 mPa·s]

### Example 3

Modified polybasic acrylic oligomer [manuf.: TOAGOSEI CO., LTD., “ARONIX M-510”, viscosity at 25 degrees C.: 3500 to 6500 mPa·s]

### Example 4

Phthalic acid monohydroxyethyl acrylate [manuf.: TOAGOSEI “ARONIX M-5400”, viscosity at 25 degrees C.: 4000 to 7000 mPa·s]

### Example 5

EO-modified-isocyanurate diacrylate [manuf.: TOAGOSEI CO., LTD., “ARONIX M-215”, viscosity at 25 degrees C.: 3500 to 15000 mPa·s]

### Example 6

Polyester acrylate (no less than trifunctional) [manuf.: TOAGOSEI CO., LTD., “ARONIX M-7100”, viscosity at 25 degrees C.: 8000 to 13500 mPa·s]

### Comparative Example 1

EO-modified phenol acrylate [manuf.: TOAGOSEI CO., LTD., “ARONIX M-101A”, viscosity at 25 degrees C.: 10 to 20 mPa·s]

### Comparative Example 2

Polyester acrylate (no less than trifunctional) [manuf.: TOAGOSEI CO., LTD., “ARONIX M-8030”, viscosity at 25 degrees C.: 560 to 960 mPa·s]

### Comparative Example 3

Modified isocyanurate diacrylate and triacrylate [manuf.: TOAGOSEI CO., LTD., “ARONIX M-313”, viscosity at 25 degrees C.: 20000 to 36000 mPa·s]

3. Evaluation Procedure

Evaluations of peeling and anticorrosive capability of the anticorrosives of different kinds were performed on the coated electric wires with the terminals that were coated with the anticorrosives.

(Peel Test)

After being applied, the anticorrosives of different kinds were individually scratched with nails. The coated electric wires with the terminals whose anticorrosives did not peel off were evaluated as PASSED. The coated electric wires with the terminals whose anticorrosives peeled off were evaluated as FAILED. It is to be noted that the anticorrosives that peeled off obviously have inferior anticorrosive capability. For this reason, the peel test was performed in advance of the evaluations of the anticorrosive capability.

(Anticorrosive Capability)

As shown in FIG. 3, each of the prepared coated electric wires 1 with the terminals was connected to a positive electrode of an electrical power source 2 of 12 volts, while a pure copper plate 3 (1 cm in width×2 cm in length×1 mm in thickness) was connected to a negative electrode of the electrical power source 2 of 12 volts. The pure copper plate 3 and the electrically connected portion between the wire conductor of each coated electric wire 1 and the terminal member were immersed in 300 cc of a water solution 4 containing 5% of NaCl, and a voltage of 12 volts was applied thereto for two minutes. After the application of the voltage, ICP emission analysis of the water solution 4 was performed to measure the amount of aluminum ions eluted from the wire conductor of each coated electric wire 1 with the terminal. The coated electric wires 1 with the terminals in which the amounts of aluminum ions eluted from the wire conductors were less than 0.1 ppm were evaluated as PASSED. The coated electric wires 1 with the terminals in which the amounts of aluminum ions eluted from the wire conductors were 0.1 ppm or more were evaluated as FAILED.

Table 1 below presents viscosities at 25 degrees C. of the anticorrosives of present Examples and Comparative Examples that were measured in accordance with the JIS Z8803, and results of the evaluation.

TABLE 1

| | Example | Example | Example | Example | Example | Example | Comparative | Comparative | Comparative |
|---|---|---|---|---|---|---|---|---|---|
| | 1 | 2 | 3 | 4 | 5 | 6 | Example 1 | Example 2 | Example 3 |
| Viscosity | 1,800~3,000 | 3,700~5,700 | 3,500~6,500 | 4,000~7,000 | 3,500~15,000 | 8,000~13,500 | 10~20 | 560~960 | 20,000~36,000 |
| (mPa · s) | | | | | | | | | |
| Peeling | PASSED | PASSED | PASSED | PASSED | PASSED | PASSED | PASSED | PASSED | PASSED |
| Anti- | PASSED | PASSED | PASSED | PASSED | PASSED | PASSED | FAILED | FAILED | FAILED |
| corrosive | | | | | | | | | |
| capability | | | | | | | | | |

As is evident from Table 1, the anticorrosives of Comparative Examples had viscosities that fell outside the range specified by the present invention. Thus, the anticorrosives of Comparative Examples were inferior in anticorrosive capability. It is assumed that the anticorrosives of Comparative Examples could not sufficiently demonstrate anticorrosive capability because the monomers and oligomers of the anticorrosives of Comparative Examples were not sufficiently penetrated into the electrically connected portions while the anticorrosives of Comparative Examples were in intimate contact with the electrically connected portions without being peeled off.

Meanwhile, the anticorrosives of the present invention had viscosities that fell within the range specified by the present invention. Thus, the anticorrosives of the present invention were sufficiently in intimate contact with the electrically connected portions, and were capable of demonstrating excellent anticorrosive capability. It is assumed that the anticorrosives of the present invention were capable of sufficiently demonstrating anticorrosive capability because the viscosities of the anticorrosives of the present invention fell within the range specified by the present invention and thus the monomers and oligomers of the anticorrosives of present invention were sufficiently penetrated into the electrically connected portions.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

For example, though the coated electric wire 10 has the configuration of including the male terminal including the tab-shaped connecting portion 14c, which defines the terminal member 14, the present invention is not limited to this configuration. It is also preferable that a female terminal capable of fitting into a male terminal, or a tuning-fork terminal is used as the terminal member 14. In addition, it is also preferable that the terminal member 14 does not include the insulation barrels 14b, and the crimp is performed only by the wire barrels 14a. In addition, the method for connecting the wire conductor 12 and the terminal member 14 is not limited to the crimp using the barrels, and it is also preferable that the wire conductor 12 and the terminal member 14 are connected by a method such as pressure-resistance welding, ultrasonic welding and soldering. In addition, though the conductor 18 defines a strand in the preferred embodiments, it is preferable that the conductor 18 defines a single wire.

1. An anticorrosive that mainly contains at least one of:
a photopolymerizable (meth)acrylate monomer; and
a photopolymerizable (meth)acrylate oligomer, and has a viscosity of 1000 mPa·s or more to less than 20000 mPa·s at 25 degrees C., which is measured in accordance with the JIS Z8803.

2. The anticorrosive according to claim 1, wherein the photopolymerizable (meth)acrylate monomer comprises an ultraviolet curable (meth)acrylate monomer, and the photopolymerizable (meth)acrylate oligomer comprises an ultraviolet curable (meth)acrylate oligomer.

3. The anticorrosive according to claim 2 that comprises an anticorrosive applied to an electrically connected portion between a wire conductor and a terminal member.

4. A coated electric wire with a terminal, the electric wire comprising a wire conductor and a terminal member, wherein an electrically connected portion between the wire conductor and the terminal member is coated with the anticorrosive according to claim 3 that is cured.

5. The coated electric wire with the terminal according to claim 4, wherein the wire conductor comprises elemental wires made of aluminum or an aluminum alloy, and the terminal member is made of copper or a copper alloy.

6. A wiring harness comprising the coated electric wire with the terminal according to claim 5.

7. A wiring harness comprising the coated electric wire with the terminal according to claim 4.

8. A coated electric wire with a terminal, the electric wire comprising a wire conductor and a terminal member, wherein an electrically connected portion between the wire conductor and the terminal member is coated with the anticorrosive according to claim 2 that is cured.

9. The coated electric wire with the terminal according to claim 8, wherein the wire conductor comprises elemental wires made of aluminum or an aluminum alloy, and the terminal member is made of copper or a copper alloy.

10. A wiring harness comprising the coated electric wire with the terminal according to claim 9.

11. A wiring, harness comprising the coated electric wire with the terminal according to claim 8.

12. A coated electric wire with a terminal, the electric wire comprising a wire conductor and a terminal member, wherein an electrically connected portion between the wire conductor and the terminal member is coated with the anticorrosive according to claim 1 that is cured.

13. The coated electric wire with the terminal according to claim 12, wherein the wire conductor comprises elemental wires made of aluminum or an aluminum alloy, and the terminal member is made of copper or a copper alloy.

14. A wiring harness comprising the coated electric wire with the terminal according to claim 13.

15. A wiring harness comprising the coated electric wire with the terminal according to claim 12.

16. The anticorrosive according to claim 1 that comprises an anticorrosive applied to an electrically connected portion between a wire conductor and a terminal member.
